(19) United States
(12) Patent Application Publication
(10) Pub. No.: US 2024/0283256 A1
(43) Pub. Date: Aug. 22, 2024

(54) MODIFYING BATTERY CHARGING ALGORITHM BASED ON CHARGING HISTORY

(71) Applicant: Atieva, Inc., Newark, VA (US)

(72) Inventors: Kevin Kimura, Mountain View, CA (US); Min Ji Namkoong, San Jose, CA (US); Justin Lui, Burlingame, CA (US); Harrison Senor, Newark, CA (US); Warren van Nus, Fremont, CA (US)

(21) Appl. No.: 18/571,918

(22) PCT Filed: Jun. 21, 2022
(86) PCT No.: PCT/US2022/073055

§ 371 Date: Dec. 19, 2023

Related U.S. Application Data
(60) Provisional application No. 63/202,736, filed on Jun. 22, 2021.

(51) Int. Cl. H02J 7/00; B60L 53/62

(52) U.S. Cl. CPC H02J 7/00036; H02J 7/0048; H02J 7/005; H02J 7/007182; H02J 7/007194; B60L 53/62

(57) ABSTRACT

A method comprises: accessing a charging history for a battery, the charging history identifying each charging session of the battery performed between a predefined time and a present time; defining, from a charging algorithm for the battery, a modified charging algorithm based at least in part on the charging history; and applying the modified charging algorithm for charging the battery.

### CROSS-REFERENCE TO RELATED APPLICATION

This application claims priority to U.S. Patent Application No. 63/202,736, filed on Jun. 22, 2021, and entitled “MODIFYING BATTERY CHARGING ALGORITHM BASED ON CHARGING HISTORY,” the disclosure of which is incorporated by reference herein in its entirety.

### TECHNICAL FIELD

This document relates to modifying a charging algorithm for a battery based at least in part on a charging history for the vehicle.

### BACKGROUND

As electric vehicles are becoming more commonplace in today's society, different approaches of charging the vehicles are being explored. Charging can take place using charging equipment installed at a public location or a private location (e.g., a place of business), or using private charging equipment installed at the home of the vehicle owner, to name just two examples. Usually, an onboard battery needs to have direct current (DC) applied to it in order to charge its electrochemical cells. For example, the DC can be provided either directly by the charging equipment. As another example, the charging equipment can provide alternating current (AC) that the vehicle converts to DC using an onboard charger. Different approaches regarding the speed of charging have been tried. Some such approaches can be associated with deterioration of the battery. For example, increased battery deterioration can cause the battery to lose its capacity over time.

### SUMMARY

In an aspect, a method comprises: accessing a charging history for a battery, the charging history identifying each charging session of the battery performed between a predefined time and a present time; defining, from a charging algorithm for the battery, a modified charging algorithm based at least in part on the charging history; and applying the modified charging algorithm for charging the battery.

Implementations can include any or all of the following features. When the charging history comprises at least one of slow charging or a rest period, generating the modified charging algorithm comprises enhancing the charging algorithm. Defining the modified charging algorithm includes increasing, for a given starting temperature or state of health of the battery, a charging current or a charging power in a relationship between (i) the charging current or the charging power and (ii) a voltage or a state of charge or a state of energy of the battery. When the relationship is graphed with the charging current or the charging power at a vertical axis of a diagram, and the voltage or the state of charge or the state of energy of the battery at a horizontal axis of the diagram, enhancing the charging algorithm comprises moving a curve upward or to the right in the diagram. Defining the modified charging algorithm includes increasing, for a given starting state of charge or voltage and state of health of the battery, a charging current or a charging power in a relationship between (i) the charging current or the charging power and (ii) a temperature or a precondition temperature of the battery. When the relationship is graphed with the charging current or the charging power at a vertical axis of a diagram, and the temperature or the precondition temperature of the battery at a horizontal axis of the diagram, enhancing the charging algorithm comprises moving a curve upward or outward in the diagram. Defining the modified charging algorithm includes increasing, for a given starting state of charge or voltage and temperature of the battery, a charging current or a charging power in a relationship between (i) the charging current or the charging power and (ii) a state of health or capacity parameter or age of the battery. When the relationship is graphed with the charging current or the charging power at a vertical axis of a diagram, and the state of health or the capacity parameter or the age of the battery at a horizontal axis of the diagram, enhancing the charging algorithm comprises moving a curve upward or to the right in the diagram. Defining the modified charging algorithm includes increasing, for a given starting state of charge or voltage, temperature, and state of health of the battery, a charging current or a charging power in a relationship between (i) the charging current or the charging power and (ii) a charging-session time for the battery. When the relationship is graphed with the charging current or the charging power at a vertical axis of a diagram, and the charging-session time at a horizontal axis of the diagram, enhancing the charging algorithm comprises moving a max portion of a curve upward or to the right in the diagram so that a total charging-session time is shorter. Defining the modified charging algorithm includes increasing, for a given starting state of charge or voltage, temperature, and state of health of the battery, a charging current or a charging power in a relationship between (i) the charging current or the charging power and (ii) a pressure parameter of the battery. When the relationship is graphed with the charging current or the charging power at a vertical axis of a diagram, and the pressure parameter at a horizontal axis of the diagram, enhancing the charging algorithm comprises moving a curve upward or to the right in the diagram. When the charging history comprises at least two fast charges back to back to each other, generating the modified charging algorithm comprises derating the charging algorithm. Defining the modified charging algorithm includes decreasing, for a given starting temperature or state of health of the battery, a charging current or a charging power in a relationship between (i) the charging current or the charging power and (ii) a voltage or a state of charge or a state of energy of the battery. When the relationship is graphed with the charging current or the charging power at a vertical axis of a diagram, and the voltage or the state of charge or the state of energy of the battery at a horizontal axis of the diagram, derating the charging algorithm comprises moving a curve downward or to the left in the diagram. Defining the modified charging algorithm includes decreasing, for a given starting state of charge or voltage and state of health of the battery, a charging current or a charging power in a relationship between (i) the charging current or the charging power and (ii) a temperature or a precondition temperature of the battery. When the relationship is graphed with the charging current or the charging power at a vertical axis of a diagram, and the temperature or the precondition temperature of the battery at a horizontal axis of the diagram, derating the charging algorithm comprises moving a curve downward or inward in the diagram. Defining the modified charging algorithm includes decreasing, for a given starting state of charge or voltage and temperature of the battery, a charging current or a charging power in a relationship between (i) the charging current or the charging power and (ii) a state of health or capacity parameter or age of the battery. When the relationship is graphed with the charging current or the charging power at a vertical axis of a diagram, and the state of health or the capacity parameter or the age of the battery at a horizontal axis of the diagram, derating the charging algorithm comprises moving a curve downward or to the left in the diagram. Defining the modified charging algorithm includes decreasing, for a given starting state of charge or voltage, temperature, and state of health of the battery, a charging current or a charging power in a relationship between (i) the charging current or the charging power and (ii) a charging-session time for the battery. When the relationship is graphed with the charging current or the charging power at a vertical axis of a diagram, and the charging-session time at a horizontal axis of the diagram, derating the charging algorithm comprises moving a max portion of a curve downward or to the left in the diagram so that a total charging-session time is longer. Defining the modified charging algorithm includes increasing, for a given starting state of charge or voltage, temperature, and state of health of the battery, a charging current or a charging power in a relationship between (i) the charging current or the charging power and (ii) a pressure parameter of the battery. When the relationship is graphed with the charging current or the charging power at a vertical axis of a diagram, and the pressure parameter at a horizontal axis of the diagram, derating the charging algorithm comprises moving a curve downward or to the left in the diagram. The method further comprises: defining a preconditioning parameter based at least in part on the charging history; and applying preconditioning to the battery according to the preconditioning parameter before charging the battery.

### BRIEF DESCRIPTION OF DRAWINGS

FIG. 1 shows an example of a system that can define a modified charging algorithm based at least in part on a charging history.

FIG. 2 shows examples of charging histories.

FIGS. 3A-3E show examples of enhancing or derating charging algorithms.

FIG. 4 shows an example of a system that can define a preconditioning parameter for a battery based at least in part on a charging history.

FIG. 5 shows examples of capacity retentions of batteries as functions of accessed miles.

Like reference symbols in the various drawings indicate like elements.

### DETAILED DESCRIPTION

This document describes examples of systems and techniques for taking into account the charging history of a vehicle in determining the charging algorithm to be applied during an upcoming charging session. The present subject matter can provide faster charging than conventional charging algorithms and methods, while protecting the battery during different use cases. In some implementations, the present subject matter can maximize a battery charge rate though a dynamic process. For example, the dynamic process can be based on recent charging history, present battery conditions, ambient conditions, available power, as well as voltage, temperature and cumulative age of the battery. In some implementations, the present subject matter can optimize charge time for a vehicle at any given starting condition while maximizing battery lifespan. For example, the user experience can be improved by shortening the charge time for a longer duration of battery ownership.

The present subject matter can provide an algorithm that builds upon a simple charging control loop, with conventional inputs such as temperature, voltage, and state of health, by enhancing or derating the algorithm based on transient inputs that reflect recent battery history. For example, ambient and/or surrounding conditions can also be taken into account. The recent history of a battery can have important implications when optimizing performance of a charging session, while extending lifetime. Some algorithms described herein can take advantage of a battery's ability to receive a relatively more aggressive (higher current/power) charge event if the recent history was relatively mild. The algorithm can allow the battery to recover after a recent aggressive history that may have semi-reversibly deteriorated the battery by applying a derated charging algorithm. In a similar vein, the ambient conditions of the battery system (e.g., battery management system (BMS), thermals, electronics, structure, etc.) can have real-time implications during charging, which allows for an enhanced charging algorithm.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle.

Examples herein refer to a battery, which is an individual component configured for holding and managing multiple electrochemical cells during charging, storage, and use. The battery can be implemented in form of one or more modules each holding at least one electrochemical cell. The battery can be intended as the sole power source for one or more loads (e.g., electric motors), or more than one battery of the same or different type can be used. Two or more batteries can be implemented in a system separately or as part of a larger energy storage unit. A battery can include control circuitry for managing the charging, storage, and/or use of electrical energy in the electrochemical cells, and/or the battery can be controlled by an external component. For example, a battery management system can be implemented on one or more circuit boards (e.g., a printed circuit board). A battery as used herein can be included in any of multiple types of system. In some implementations, a battery is included in a vehicle. Such a vehicle can include a battery electric vehicle, a plug-in hybrid vehicle, a plug-in fuel cell electric vehicle, an electric vehicle, an all-electric vehicle, a hybrid-electric powered vertical takeoff and landing vehicle, an electric marine vehicle, a small electric mobility option including, but not limited to, an e-bike or a scooter. In some implementations, a battery as used herein can be included in portable/personal electronics, and/or other electric machines.

Examples herein refer to electrochemical cells. An electrochemical cell can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrolytic cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples herein refer to fast charging. As used herein, a fast charge means a charging session that reaches a current greater than 0.2 C, where 1 C is the current that will discharge the entire battery in one hour.

Examples herein refer to slow charging. As used herein, a slow charge means a charging session that reaches a current smaller than or equal to 0.2 C.

Examples herein refer to a charging history of a battery. As used herein, a charging history for a vehicle identifies each charging session of the vehicle performed between a predefined time and a present time. The charging history includes a specific range of time beginning at the predefined time and ending at the present time. In some implementations, the predefined time specifies a point in time one or more days in the past. The predefined time can be 10, 9, 8, 7, 6, 5, 4, 3, or 2 days in the past, or 1 day in the past, to name just a few examples. As another example, the predefined time can be on the order of hours in the past.

Examples herein refer to a charging current of a battery. As used herein, a charging current of a battery refers to the current that is being, or will be, applied to charge the battery. The system controlling the battery (e.g., a BMS) can control the charging current that is supplied to the battery. For example, the BMS can specify the charging current to charging equipment so that the charging equipment is controlled to supply the correct charging current.

Examples herein refer to a charging power of a battery. As used herein, a charging power of a battery refers to the power that is being, or will be, applied to charge the battery. The system controlling the battery (e.g., a BMS) can control the charging power that is supplied to the battery. For example, the BMS can specify the charging power to charging equipment so that the charging equipment is controlled to supply the correct charging power.

Examples herein refer to one or more voltages of a battery. As used herein, a voltage of a battery can include any of multiple voltage parameters relating to a battery and/or one or more electrochemical cells. In some implementations, the voltage can refer to a terminal voltage, an open-circuit voltage (OCV), a half-cell voltage, an overpotential, a polarization, and/or any other partial voltage measurement, to name just a few examples.

Examples herein refer to a state of charge (SOC) of a battery. As used herein, an SOC can include any of multiple SOC parameters relating to a battery and/or one or more electrochemical cells. In some implementations, SOC captures one or more measurements of lithiation percentage of the anode, de-lithiation of the cathode, and/or overall potential capacity or energy in the cell.

Examples herein refer to a state of energy (SOE) of a battery. As used herein, an SOE can include any of multiple SOE parameters relating to a battery and/or one or more electrochemical cells. In some implementations, SOE captures one or more measurements of lithiation percentage of the anode, de-lithiation of the cathode, and/or overall potential capacity or energy in the cell.

Examples herein refer to a temperature of a battery. As used herein, a temperature of a battery can include any of multiple temperature parameters relating to a battery and/or one or more electrochemical cells. In some implementations, a temperature includes a temperature of at least one part of a battery pack, and/or a temperature of an inside core of a cell, to name just two examples.

Examples herein refer to state of health (SOH) of a battery. As used herein, an SOH of a battery can include any of multiple SOH relating to a battery and/or one or more electrochemical cells. In some implementations, SOH captures any metric indicating how the present performance of the battery compares to its performance at the beginning of its life. For example, SOH can include, but is not limited to, capacity retention, impedance change, OCV change, a change in differential capacity (e.g., dQ/dV, where dQ is a change in capacity and dV is a change in potential), and/or a change in duration of a charging segment (e.g., a constant-voltage charging segment), to name just a few examples.

Examples herein refer to a capacity parameter of a battery. As used herein, a capacity parameter of a battery can include any of multiple capacity metrics relating to a battery and/or one or more electrochemical cells. In some implementations, a capacity parameter can include accumulated capacity, accumulated energy, accumulated number of charging cycles, and/or accumulated mileage of a vehicle, to name just a few examples.

Examples herein refer to an age of a battery. As used herein, an age of a battery can include any of multiple age parameters relating to a battery and/or one or more electrochemical cells. In some implementations, an age can include an SOH of the battery, a capacity parameter of the battery, and/or a calendar age of the battery. For example, the calendar age of the battery indicates the time elapsed since the beginning of the battery's life.

Examples herein refer to a charging-session time of a battery. As used herein, a charging-session time of a battery includes the planned or actual duration of the charging session (e.g., in terms of the amount of time elapsed).

Examples herein refer to pressure parameter of a battery. As used herein, a pressure parameter of a battery can include any of multiple pressure metrics relating to a battery and/or one or more electrochemical cells. In some implementations, pressure includes swelling, liquid volume expansion, solid volume expansion, mechanical pressure (e.g., inside a cell), and/or gas pressure (e.g., inside a cell), to name just a few examples. A pressure-change parameter (e.g., ΔP) can include any combination of a change in pressure (e.g., a change in a pressure parameter) and a variable mentioned elsewhere herein (e.g., a change in pressure in relation to a change in time). In some implementations, a pressure can be determined using a physical sensor. For example, a physical pressure sensor can be punctured into a cell in the battery, and/or a strain gauge can measure expansion of the cell, to name just a few examples. In some implementations, a pressure can be determined using a model. For example, the model can take into account one or more characteristics or parameters regarding a battery or a cell, and provide a model output as an indication of the present pressure parameter.

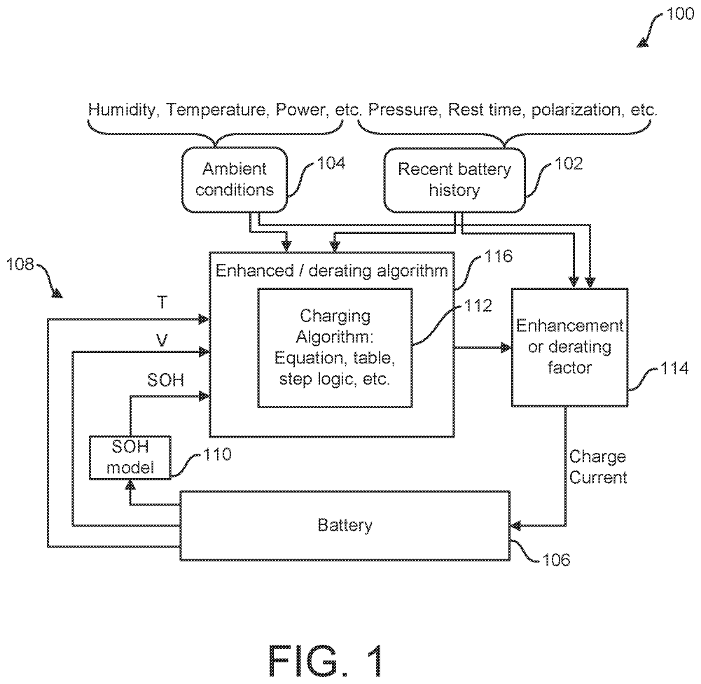

FIG. 1 shows an example of a system 100 that can define a modified charging algorithm based at least in part on a charging history 102 (e.g., a recent battery history). The system 100 can be used with one or more other examples described elsewhere herein. In some implementations, one or more ambient conditions 104 and a recent battery history from the charging history 102 can be provided as real-time, dynamic inputs in a control loop for enhanced/derated fast charging of a battery 106. For example, the system 100 is here illustrated using a flow diagram showing various possible inputs to the ambient conditions 104 (e.g., humidity, temperature, and/or power, etc.) and various possible inputs to the charging history 102 (e.g., pressure, rest time, and/or polarization, etc.). The inputs feed into a fast-charge control loop (e.g., a bottom loop in this illustration). A charging algorithm can be enhanced or derated by changing the algorithm itself and/or by applying a factor based on the dynamic inputs (recent battery history, optionally together with ambient conditions).

The charging history 102 can indicate a recent cell history of the battery 106 by identifying each charging session of the battery 106 performed between a predefined time and a present time. For example, each time the battery 106 is charged, the system 100 can update the charging history regarding the specifics of the charging session. The charging history 102 and ambient conditions 104 can capture short-term aging factors that will be taken into account before and during the fast-charging session. These factors may include, but are not limited to, absolute pressure, pressure over a length of time or cumulative capacity (e.g., ΣAh), recent average/root mean square charge or discharge current, built-up polarization in the negative or positive directions, previous temperatures, previous temperature change, and/or previous rest times, to name just a few examples.

The charging history 102 can include various inputs related to the electrochemical and physical changes that the battery has experienced recently. For example, electrochemical changes such as the relaxation of polarization and decreased impedance in the battery caused by prolonged rests and mild cycling in the recent history can allow room for an enhanced charging event. Furthermore, the immediate polarization and resistance of the battery before a charging session can also be compensated for to allow for an enhanced or derated charging event. Polarization can include ionic polarization in one or more individual cells. In some implementations, polarization can be detected and/or determined by measuring an overpotential of the cell(s). An overpotential, moreover, can be calculated based on SOC and an open-circuit detection (OCD) of the cell at a given temperature. For example, when a voltage is measured, the OCD can be subtracted to obtain the overpotential, and therefore the polarization. In some implementations, polarization can be measured by dV/dt, the rate of voltage change over time. For example, the rate of voltage drop before a rest period can be compared with the rate of voltage drop after the rest period to determine the amount of polarization. In some implementations, a polarization model can be used.

A physical change occurring in the cell(s) could be gas generation or gas dissolution resulting in a change in pressure. A direct or indirect measurement of pressure as well as an online/offline model of the pressure in the cell could provide absolute and pressure-change growth over the recent history of the battery. In simple terms, lower or decreasing pressures may indicate room for an enhanced fast charge and vice versa. Other physical changes could include, but are not limited to, volumetric changes in the battery materials, resulting a stress/strain variations over time. Recent temperature history and temperature-change history are physical changes that could inform the optimal charge.

The battery 106 can provide one or more characteristics 108. In some implementations, the characteristic(s) 108 can indicate one or more operational aspects of the battery 106. The characteristic(s) 108 can indicate a temperature (T), a voltage (V), and/or an SOH of the battery 106. In some implementations, the SOH can be determined using an SOH model 110 based on one or more sensor readings or other outputs of the battery 106. For example, the SOH model 110 captures, under some metric (e.g., a 1-to-0 parameter), an indication of how the battery 106 compares to itself at the beginning of its life (e.g., in terms of its remaining discharge capacity).

One or more approaches can be used for controlling a charging algorithm 112 based at least in part on the charging history 102. For example, if the most recent charging sessions involved back-to-back aggressive charging, the protocol of the charging algorithm 112 can be derated appropriately based on a safe charge. As another example, if the previous charging sessions were slow charges then the protocol of the charging algorithm 112 can be enhanced.

In some implementations, a factor 114 can be applied to the charging algorithm 112 to define a modified charging algorithm. The factor 114 can be referred to as an enhancement or derating factor and can involve applying a constant value to the charging algorithm 112. For example, if a parameter of the charging algorithm 112 is 1.0, then the parameter can be adjusted to 1.2 (e.g., by enhancement) or to 0.8 (e.g., by derating). In some implementations, the factor 114 can be nonlinear enhancement or derating factor, or the factor 114 can be applied to one or more aspects of the charging algorithm 112 while others have a different factor (or no factor) applied.

In some implementations, an algorithm 116 can be applied to the charging algorithm 112 to define a modified charging algorithm. The algorithm 116 can be referred to as an enhancement or derating algorithm and can involve changing the charging algorithm 112 more substantially than merely applying the factor(s) in the previous example. In some implementations, a charging algorithm may only be implemented once a vehicle reaches a certain age (e.g., 50,000 miles). Such a vehicle is a little aged so one should not apply charging that is too fast. Considering the charging history 102, however, it can be determined that the vehicle has rested for over a week and the only charging sessions applied in the most recent month have been slow charges. Accordingly, it may be possible to push the charging somewhat for the vehicle at this point. The algorithm 116 can then modify the charging algorithm 112 to define a modified charging algorithm that is a different schema than the charging algorithm 112. The modified charging algorithm, moreover, may be a schema that was regularly applied to the vehicle earlier in its lifetime, but that had since been replaced with the charging algorithm 112.

In short, with reference to the previous examples, the short-term age factors that are addressed by taking into account the charging history 102 can exist within a time span that is on the order of about one or more days. The functionality of the battery 106 based on the charging algorithm 112—or a modified charging algorithm, as the case may be—can be based on operations performed within a time span that is on the order of about a second or less (e.g., a fraction of a second, including, but not limited to, on a millisecond level). The SOH as indicated by the characteristics 108 (e.g., based on the SOH model 110), finally, can indicate circumstances that remain substantially unchanged over significant periods of time (e.g., on the order of about one or more years).

Operation of the system 100 illustrates an example of performing a method that includes accessing a charging history for a vehicle (e.g., the charging history 102), the charging history identifying each charging session of the vehicle performed between a predefined time and a present time. The method includes defining a modified charging algorithm based at least in part on the charging history. The modified charging algorithm is defined from a charging algorithm (e.g., the charging algorithm 112) for the vehicle. The method includes applying the modified charging algorithm for charging the battery (e.g., as part of the bottom loop of the system 100).

The ambient conditions 104 can be taken into account by the factor 114 and/or by the algorithm 116. The ambient conditions and available power can include inputs regarding real-time factors such as the outside humidity, outside temperature, structural temperature, air flow, available pack power, available charger power, and/or other short-term factors, to name just a few examples. Depending on these real-time conditions, the effective cooling/heating power for the system can be considered.

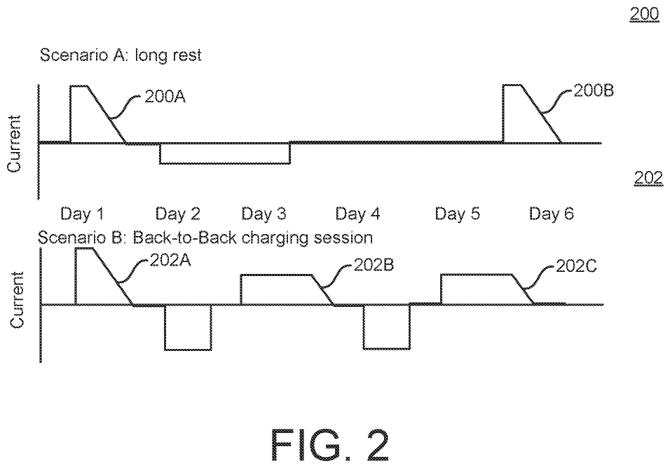

FIG. 2 shows examples of charging histories 200 and 202. The charging histories 200 and/or 202 can be used with one or more other examples described otherwhere herein. Each of the charging histories 200 and 202 is here illustrated using a diagram that shows charging current on a vertical axis and time (e.g., in terms of days) on a horizontal axis. Charging sessions occur when the graph is above the horizontal axis and discharge sessions occur when the graph is below the horizontal axis.

The charging history 200 shows a long rest time between charging sessions 200A and 200B. For example, this can allow for applying a more enhanced charging current, and each of the charging sessions 200A-200B is therefore an enhanced charging session. The charging history 202 shows a back-to-back charging scenario where there is very little rest time. For example, the enhanced charging algorithm can be applied for a first charging session 202A, but subsequent sessions 202B and 202C are derated.

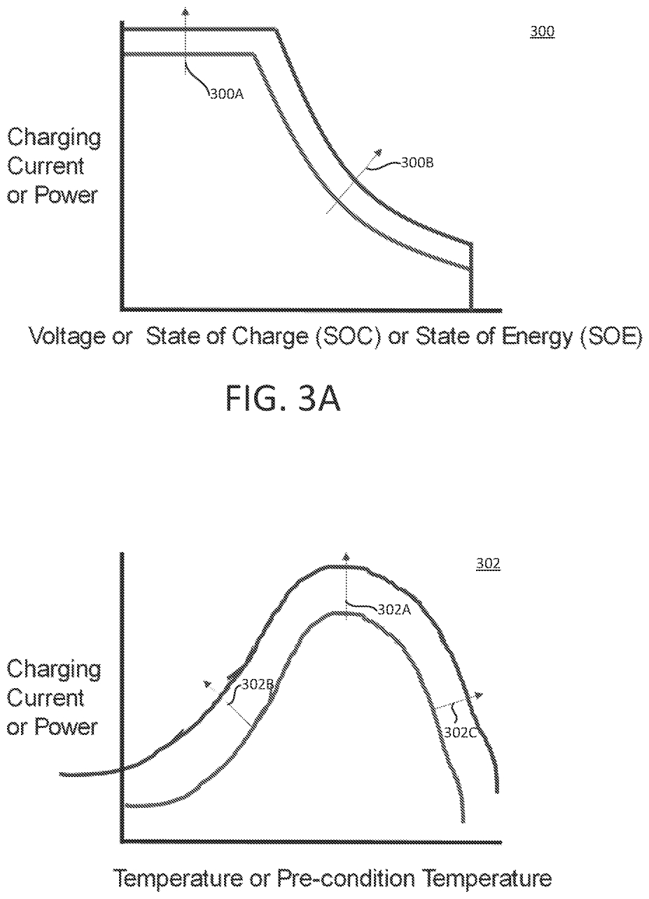

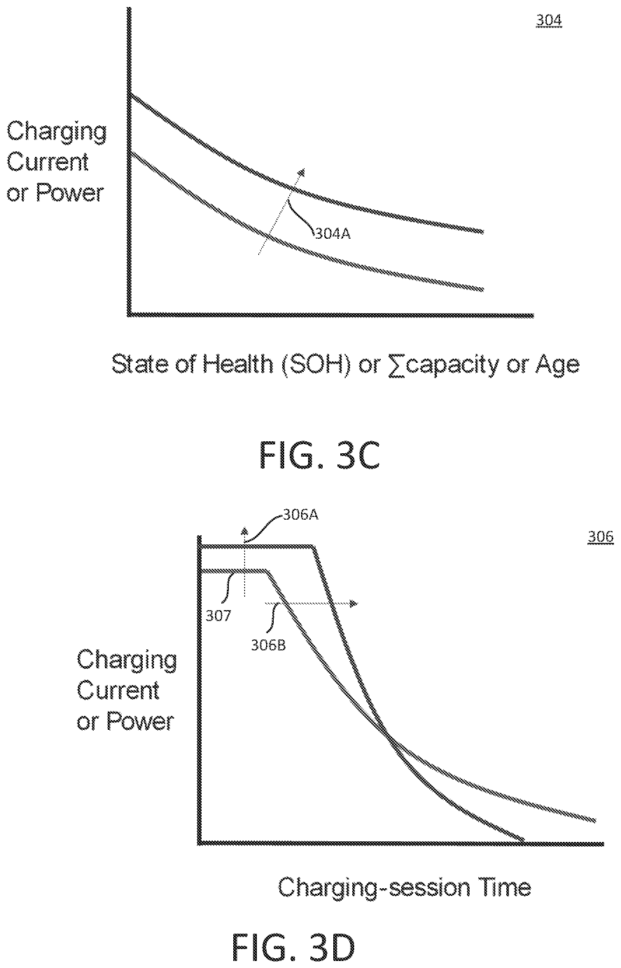

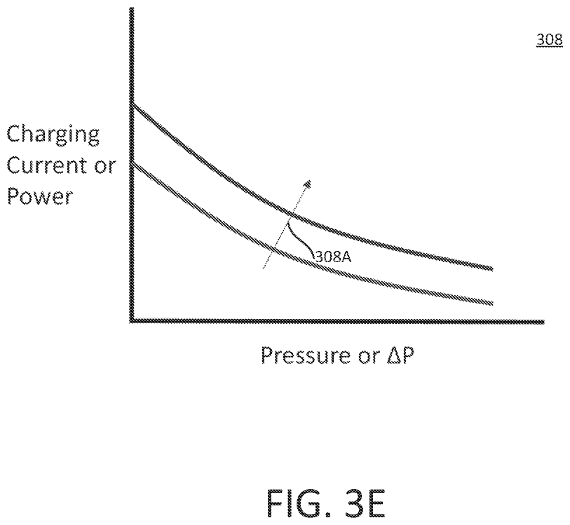

FIGS. 3A-3E show examples of enhancing or derating charging algorithms. Any or all of diagrams 300-308 in FIGS. 3A-3E can be used with one or more other examples described otherwhere herein. Each of the diagrams 300-308 is here illustrated with charging current or charging power on a vertical axis and another variable on a horizontal axis.

FIG. 3A shows the diagram 300 defining a relationship between the charging current or charging power on the vertical axis and voltage or SOC or SOE on the horizontal axis. The diagram 300 applies for a given starting temperature or SOH of the battery. Enhancing the charging algorithm can include moving the curve upward and/or to the right in the diagram 300. For example, an arrow 300A schematically illustrates a curve being moved upward. As another example, an arrow 300B schematically illustrates the curve being moved upward and to the right. Derating the charging algorithm can be done in an opposite fashion. For example, a curve can be moved downward in a direction opposite to that of the arrow 300A. As another example, a curve can be moved downward and to the left in a direction opposite to that of the arrow 300B. Other approaches for enhancing or derating the algorithm can be used.

FIG. 3B shows the diagram 302 defining a relationship between the charging current or charging power on the vertical axis and a temperature or a precondition temperature of the battery on the horizontal axis. The precondition temperature can indicate the intended temperature of the battery at an upcoming charging session. The diagram 302 applies for a given starting SOC or voltage and SOH of the battery. Enhancing the charging algorithm can include moving the curve upward and/or outward in the diagram 302. For example, an arrow 302A schematically illustrates a curve being moved upward. As another example, arrows 302B-302C schematically illustrate the curve being moved outward. Derating the charging algorithm can be done in an opposite fashion. For example, a curve can be moved downward in a direction opposite to that of the arrow 302A. As another example, a curve can be moved inward in a direction opposite to that of either of the arrows 302B-302C. Other approaches for enhancing or derating the algorithm can be used.

FIG. 3C shows the diagram 304 defining a relationship between the charging current or charging power on the vertical axis and an SOH or capacity parameter or age of the battery on the horizontal axis. The diagram 304 applies for a given starting SOC or voltage and temperature of the battery. Enhancing the charging algorithm can include moving the curve upward and/or to the right in the diagram 304. For example, an arrow 304A schematically illustrates a curve being moved upward and to the right. Derating the charging algorithm can be done in an opposite fashion. For example, a curve can be moved downward and to the left in a direction opposite to that of the arrow 304A. Other approaches for enhancing or derating the algorithm can be used.

FIG. 3D shows the diagram 306 defining a relationship between the charging current or charging power on the vertical axis and a charging-session time for the battery on the horizontal axis. The diagram 306 applies for a given starting SOC or voltage, temperature, and SOH of the battery. Enhancing the charging algorithm can include moving a max portion 307 of the curve upward and/or to the right in the diagram 306. For example, an arrow 306A schematically illustrates the max portion 307 being moved upward so that a total charging-session time is shorter, as indicated on the horizontal axis. As another example, an arrow 306B schematically illustrates the max portion 307 being moved to the right so that the total charging-session time is shorter, as indicated on the horizontal axis. Derating the charging algorithm can be done in an opposite fashion. For example, a curve can be moved downward in a direction opposite to that of the arrow 306A so that the total charging-session time is longer, as indicated on the horizontal axis. As another example, a curve can be moved to the left in a direction opposite to that of the arrow 306B so that the total charging-session time is longer, as indicated on the horizontal axis. Other approaches for enhancing or derating the algorithm can be used.

FIG. 3E shows the diagram 308 defining a relationship between the charging current or charging power on the vertical axis and a pressure parameter of the battery on the horizontal axis. The diagram 308 applies for a given starting SOC or voltage, temperature, and SOH of the battery. Enhancing the charging algorithm can include moving the curve upward and/or to the right in the diagram 308. For example, an arrow 308A schematically illustrates a curve being moved upward and to the right. Derating the charging algorithm can be done in an opposite fashion. For example, a curve can be moved downward and to the left in a direction opposite to that of the arrow 308A. Other approaches for enhancing or derating the algorithm can be used.

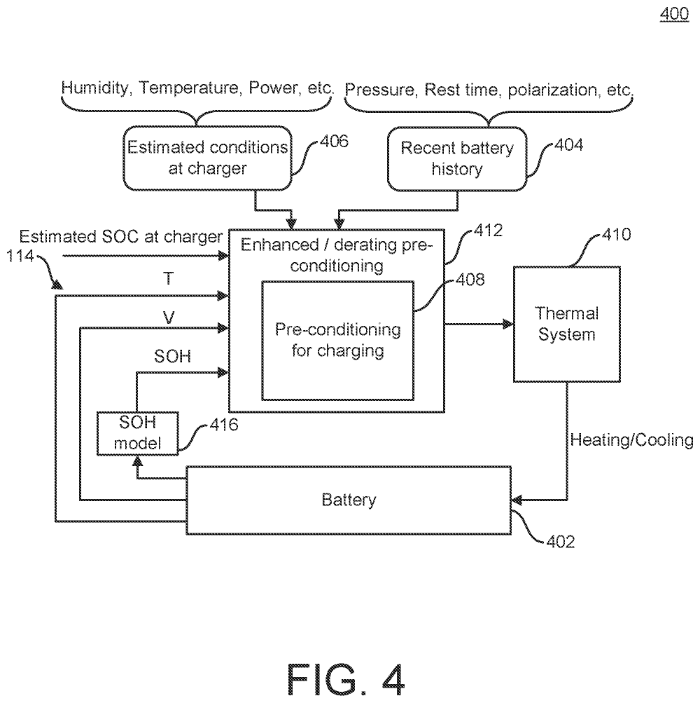

The preconditioning algorithm to prepare a battery for the charging session can also take into account similar dynamic inputs such as estimated conditions at the charger or the recent battery history. FIG. 4 shows an example of a system 400 that can define a preconditioning parameter for a battery 402 based at least in part on a charging history 404. That is, the system 400 can decide how to precondition the battery 402 by takin into account how the battery 402 has been charged previously. Here, an estimated SOC at the charger along with typical inputs from the battery are fed into a preconditioning loop, and are adjusted by taking dynamic inputs. For example, if the charger is estimated to be in a hot location or have decreased power available, the preconditioning may purposely keep the battery cooler to compensate for lesser cooling power. As another example, if there has been a recent build up in battery pressure, the preconditioning may choose a temperature best suited to mitigate gas generation. The system 400 can be used with one or more other examples described otherwhere herein.

In some implementations, one or more conditions 406 (e.g., at the charging station) and a recent battery history from the charging history 404 can be provided as real-time, dynamic inputs in a control loop for enhanced/derated preconditioning of the battery 402. For example, the system 400 is here illustrated using a flow diagram showing various possible inputs to the ambient conditions 406 (e.g., humidity, temperature, and/or power, etc.) and various possible inputs to the charging history 404 (e.g., pressure, rest time, and/or polarization, etc.). The inputs feed into a preconditioning control loop (e.g., a bottom loop in this illustration). A preconditioning algorithm 408 can be enhanced or derated by changing the algorithm itself based on the dynamic inputs (recent battery history, optionally together with ambient conditions). For example, a thermal system 410 of the vehicle can precondition the battery 402 according to the preconditioning algorithm 408.

The battery 402 can provide one or more characteristics 414. In some implementations, the characteristic(s) 414 can indicate one or more operational aspects of the battery 402. The characteristic(s) 414 can indicate a temperature (T), a voltage (V), and/or an SOH of the battery 106. In some implementations, the SOM can be determined using an SOH model 416 based on one or more sensor readings or other outputs of the battery 402. For example, the SOH model 416 captures, under some metric (e.g., a 1-to-0 parameter), an indication of how the battery 106 compares to itself at the beginning of its life (e.g., in terms of its remaining discharge capacity).

In short, the algorithm 412 can define a preconditioning parameter (e.g., the resulting temperature of the battery 402 at the charging station) based at least in part on the charging history 404. The thermal system 410 can apply preconditioning to the battery 402 according to the preconditioning parameter before the battery is charged.

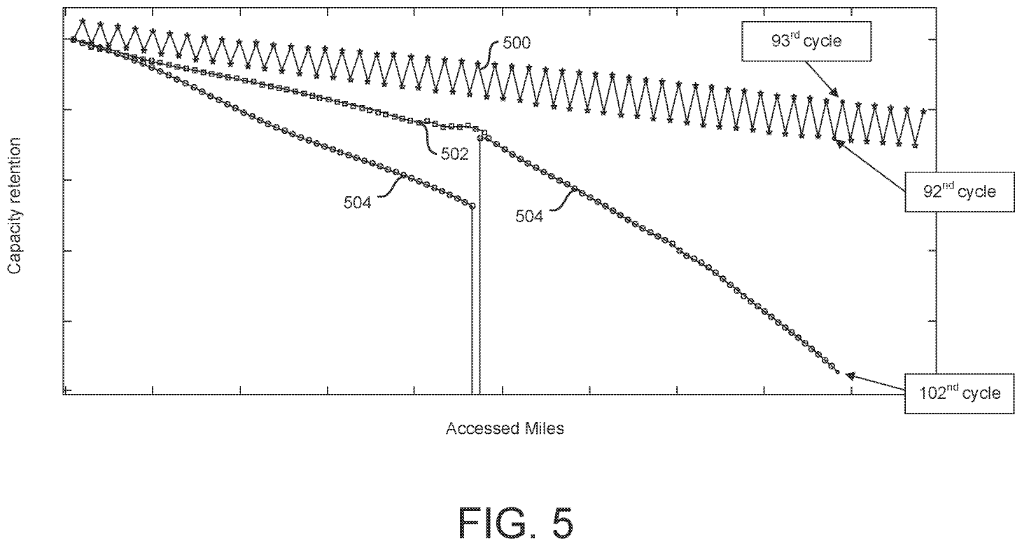

FIG. 5 shows examples of capacity retentions of batteries as functions of accessed miles. The examples are shown in graphs 500, 502, and 504, respectively. The accessed miles can be determined by using energy per cycle, where every cycle gives a certain amount of energy, and there is a direct correlation between energy and miles. Any or all of the graphs 500, 502, and 504 can be used with one or more other examples described otherwhere herein.

The graphs 500, 502, and 504 exemplify initial tests focused on recent battery charging history. For this study, three cycling patterns were chosen: Back-to-Back (B2B) Fast Charge (FC), corresponding to the graph 504, which has two segments positioned at respective sides of the middle of the diagram; a Fast Charge then Rest (FC-R), corresponding to the graph 502 (which ends approximately at the middle of the diagram); and a Fast Charge then Slow Charge (FC-SC), corresponding to the graph 500. During the testing that generated the graph 504, the repeated pattern of charging and discharging was interrupted and then resumed, leading to a recovery in the capacity retention as indicated by the different segments of the graph 504.

In each of the graphs 500, 502, and 504, the FC protocol started from 0% SOC then charged to 100% SOC, with more than 65% SOC within the first 20 minutes of charging. Here, slow charge spanned the same SOC window but charging and discharging was done at 0.2 C. Rest in FC-R was for 8 hours. The illustration visualizes the electrochemical result from the study. Particularly, a derated subsequent charge after a Fast Charge improves the health of the cell.

Each dot in the graphs 500, 502, and 504 is one cycle discharge capacity. The graphs 500, 502, and 504 reflect measurements done at the cell level. Discharging the cell from full SOC to zero SOC gives a capacity value. The capacity values are normalized to the beginning of the life for the cells using a 0-1 scale. In the graph 500, the capacity increases from the first data point to the second because slow charging is more mild than fast charging. Slow charging is akin to connecting to a Level 2 charger in a home, not a 200-350 KW charger.

The graphs 500, 502, and 504 can be interpreted by looking at similar mileage. Here, the 102nd cycle of the graph 504 is about the same number of accessed miles as the cycles 92 and 93 of the graph 500. The capacity retention of the graph 500 at this point, having accessed about the same number of miles as in the graph 504, is significantly greater than that of the graph 504.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
accessing a charging history for a battery, the charging history identifying each charging session of the battery performed between a predefined time and a present time;
defining, from a charging algorithm for the battery, a modified charging algorithm based at least in part on the charging history; and
applying the modified charging algorithm for charging the battery.

2. The method of claim 1, wherein when the charging history comprises at least one of slow charging or a rest period, generating the modified charging algorithm comprises enhancing the charging algorithm.

3. The method of claim 2, wherein defining the modified charging algorithm includes increasing, for a given starting temperature or state of health of the battery, a charging current or a charging power in a relationship between (i) the charging current or the charging power and (ii) a voltage or a state of charge or a state of energy of the battery.

4. The method of claim 3, wherein, when the relationship is graphed with the charging current or the charging power at a vertical axis of a diagram, and the voltage or the state of charge or the state of energy of the battery at a horizontal axis of the diagram, enhancing the charging algorithm comprises moving a curve upward or to the right in the diagram.

5. The method of claim 2, wherein defining the modified charging algorithm includes increasing, for a given starting state of charge or voltage and state of health of the battery, a charging current or a charging power in a relationship between (i) the charging current or the charging power and (ii) a temperature or a precondition temperature of the battery.

6. The method of claim 5, wherein, when the relationship is graphed with the charging current or the charging power at a vertical axis of a diagram, and the temperature or the precondition temperature of the battery at a horizontal axis of the diagram, enhancing the charging algorithm comprises moving a curve upward or outward in the diagram.

7. The method of claim 2, wherein defining the modified charging algorithm includes increasing, for a given starting state of charge or voltage and temperature of the battery, a charging current or a charging power in a relationship between (i) the charging current or the charging power and (ii) a state of health or capacity parameter or age of the battery.

8. The method of claim 7, wherein, when the relationship is graphed with the charging current or the charging power at a vertical axis of a diagram, and the state of health or the capacity parameter or the age of the battery at a horizontal axis of the diagram, enhancing the charging algorithm comprises moving a curve upward or to the right in the diagram.

9. The method of claim 2, wherein defining the modified charging algorithm includes increasing, for a given starting state of charge or voltage, temperature, and state of health of the battery, a charging current or a charging power in a relationship between (i) the charging current or the charging power and (ii) a charging-session time for the battery.

10. The method of claim 9, wherein, when the relationship is graphed with the charging current or the charging power at a vertical axis of a diagram, and the charging-session time at a horizontal axis of the diagram, enhancing the charging algorithm comprises moving a max portion of a curve upward or to the right in the diagram so that a total charging-session time is shorter.

11. The method of claim 2, wherein defining the modified charging algorithm includes increasing, for a given starting state of charge or voltage, temperature, and state of health of the battery, a charging current or a charging power in a relationship between (i) the charging current or the charging power and (ii) a pressure parameter of the battery.

12. The method of claim 11, wherein, when the relationship is graphed with the charging current or the charging power at a vertical axis of a diagram, and the pressure parameter at a horizontal axis of the diagram, enhancing the charging algorithm comprises moving a curve upward or to the right in the diagram.

13. The method of claim 1, wherein when the charging history comprises at least two fast charges back to back to each other, generating the modified charging algorithm comprises derating the charging algorithm.

14. The method of claim 13, wherein defining the modified charging algorithm includes decreasing, for a given starting temperature or state of health of the battery, a charging current or a charging power in a relationship between (i) the charging current or the charging power and (ii) a voltage or a state of charge or a state of energy of the battery.

15. The method of claim 14, wherein, when the relationship is graphed with the charging current or the charging power at a vertical axis of a diagram, and the voltage or the state of charge or the state of energy of the battery at a horizontal axis of the diagram, derating the charging algorithm comprises moving a curve downward or to the left in the diagram.

16. The method of claim 13, wherein defining the modified charging algorithm includes decreasing, for a given starting state of charge or voltage and state of health of the battery, a charging current or a charging power in a relationship between (i) the charging current or the charging power and (ii) a temperature or a precondition temperature of the battery.

17. The method of claim 16, wherein, when the relationship is graphed with the charging current or the charging power at a vertical axis of a diagram, and the temperature or the precondition temperature of the battery at a horizontal axis of the diagram, derating the charging algorithm comprises moving a curve downward or inward in the diagram.

18. The method of claim 13, wherein defining the modified charging algorithm includes decreasing, for a given starting state of charge or voltage and temperature of the battery, a charging current or a charging power in a relationship between (i) the charging current or the charging power and (ii) a state of health or capacity parameter or age of the battery.

19. The method of claim 18, wherein, when the relationship is graphed with the charging current or the charging power at a vertical axis of a diagram, and the state of health or the capacity parameter or the age of the battery at a horizontal axis of the diagram, derating the charging algorithm comprises moving a curve downward or to the left in the diagram.

20. The method of claim 13, wherein defining the modified charging algorithm includes decreasing, for a given starting state of charge or voltage, temperature, and state of health of the battery, a charging current or a charging power in a relationship between (i) the charging current or the charging power and (ii) a charging-session time for the battery.

21. The method of claim 20, wherein, when the relationship is graphed with the charging current or the charging power at a vertical axis of a diagram, and the charging-session time at a horizontal axis of the diagram, derating the charging algorithm comprises moving a max portion of a curve downward or to the left in the diagram so that a total charging-session time is longer.

22. The method of claim 13, wherein defining the modified charging algorithm includes increasing, for a given starting state of charge or voltage, temperature, and state of health of the battery, a charging current or a charging power in a relationship between (i) the charging current or the charging power and (ii) a pressure parameter of the battery.

23. The method of claim 22, wherein, when the relationship is graphed with the charging current or the charging power at a vertical axis of a diagram, and the pressure parameter at a horizontal axis of the diagram, derating the charging algorithm comprises moving a curve downward or to the left in the diagram.

24. The method of claim 1, further comprising:
defining a preconditioning parameter based at least in part on the charging history; and
applying preconditioning to the battery according to the preconditioning parameter before charging the battery.
